(19) United States
(12) Patent Application Publication
(10) Pub. No.: US 2024/0268588 A1
(43) Pub. Date: Aug. 15, 2024

(54) NON-SLIP COLD-RESISTANT LOOP MAT AND MANUFACTURING METHOD THEREFOR

(71) Applicant: TAICANG ALL MATS PLASTIC INDUSTRY CO., LTD., Suzhou, Jiangsu (CN)

(72) Inventor: Tsong Ming Yaw, Suzhou, Jiangsu (CN)

(21) Appl. No.: 17/753,815

(22) PCT Filed: Sep. 7, 2020
(86) PCT No.: PCT/CN2020/113743

§ 371 Date: Jul. 29, 2022

(30) Foreign Application Priority Data
Sep. 16, 2019 (CN) 201910870122.9

(51) Int. Cl. A47G 27/02; B29C 37/00; B29C 69/00; B29D 99/00; B29K 227/06; B29L 31/00

(52) U.S. Cl. CPC A47G 27/0281; B29C 37/0025; B29C 69/001; B29D 99/0057; B29K 2227/06; B29K 2995/0015; B29L 2031/7324

(57) ABSTRACT

A non-slip cold-resistant loop mat and a manufacturing method therefor. The non-slip cold-resistant loop mat includes a non-slip mesh layer (1) and a loop layer arranged on the non-slip mesh layer (1); the loop layer includes a flat loop base layer, and a plurality of vertical filaments (2) and a plurality of arched loops (3) erected on the loop base layer; both the vertical filaments (2) and the arched loops (3) are provided with particles (4); the non-slip mesh layer (1) is of a porous structure; upper ends of the vertical filaments (2) extend upwards; the arched loops (3) are vertically arranged; and the particles (4) are fixed on the vertical filaments (2) and the arched loops (3) in an adhesive manner. The influence of the temperature on the overall hardness of the loop mat is small, and the anti-slip performance of the loop mat is improved.

### TECHNICAL FIELD OF THE INVENTION

The present disclosure relates to the plastic floor mat field, in particular to a non-slip cold-resistant loop mat and a manufacturing method therefor.

### BACKGROUND OF THE INVENTION

At present, the common loop mat in the market is an integrated mat material formed from a loop surface layer and a bottom supporting base material through hot-melt bonding or glue bonding, and the loop mat has a good sand scraping effect. However, the loop mat in the prior art has poor cold resistance, and in rainy, snowy, or cold weather, the hardness of the plastic increases, and the anti-slip effect decreases, which brings potential risks. Considering that the wet state and temperature changes have a great influence on the slip-resistance performance of plastics, it is desired to develop a new non-slip cold-resistant loop mat from the aspect of the surface roughness of the material and that the material is not affected or less affected by temperature.

### SUMMARY OF THE INVENTION

To solve the technical problems of the prior art, the present disclosure provides a non-slip cold-resistant loop mat and a manufacturing method therefor, and the technical solutions are as follows:

In an aspect, a non-slip cold-resistant loop mat is disclosed, wherein it comprises a non-slip mesh layer, a plurality of vertical filaments and a plurality of arched loops arranged on the non-slip mesh layer, and particles arranged on the vertical filaments and the arched loops, wherein the non-slip mesh layer is of a porous structure, and the material for manufacturing the non-slip mesh layer comprises PVC and glass fibers;
lower ends of the vertical filaments are fixed on the non-slip mesh layer in an adhesive manner, upper ends of the vertical filaments extend upwards, and the height of the vertical filaments ranges from 8 to 16 mm;
two ends of the arched loops are respectively fixed on the non-slip mesh layer in an adhesive manner, the arched loops are erectly arranged, and the height of the arched loops ranges from 6 to 12 mm;
the vertical filaments and the arched loops are made of cold-resistant material, and the cold-resistant material comprises polyvinyl chloride, toughened resin, plasticizer, cold-resistant plasticizer, stabilizer, lubricant, and calcium carbonate;
the particles are fixed on the vertical filaments and the arched loops in an adhesive manner, the material for manufacturing the particles comprises PVC resin powder, wood chips and fine sand, and the particle size of the particles ranges from 100 to 500 μm.

Further, the non-slip mesh layer is provided with square eyelets, the eyelets are arranged in an array, the side length of the eyelets ranges from 4 to 10 mm, the distance between adjacent eyelets in the same row ranges from 9 to 21 mm, and the distance between adjacent eyelets in the same column ranges from 9 to 21 mm.

Optionally, the filament diameter of the vertical filaments ranges from 0.4 to 1 mm.

Optionally, the filament diameter of the arched loops ranges from 0.4 to 1 mm.

Further, the weight parts of the cold-resistant material are:

| | | |
|---|---|---|
| polyvinyl chloride | 5~100 | parts |
| toughened resin | 5~20 | parts |
| plasticizer | 50~80 | parts |
| cold-resistant plasticizer | 5~20 | parts |
| stabilizer | 3~6 | parts |
| lubricant | 0~1 | part |
| calcium carbonate | 30~50 | parts. |

Optionally, the vertical filaments are formed by cutting a part of the arched loops at respective highest point thereof.

Further, the quantity ratio of the vertical filaments to the arched loops is less than or equal to 1:1.

Preferably, the difference between the hardness value of the vertical filaments at 0° C. and the hardness value at 25° C. is no more than 4 HA; the difference between the hardness value of the arched loops at 0° C. and the hardness value at 25° C. is no more than 4 HA.

Further, outer layers of the vertical filaments and of the arched loops are covered with a layer of adhesive layer, the vertical filaments and the arched loops are fixed on the non-slip mesh layer through an adhesive layer, the particles comprise a plurality of particles with the same or different particle sizes, and the particles are fixed on the vertical filaments and the arched loops through the adhesive layer.

In another aspect, a second non-slip cold-resistant loop mat is disclosed, wherein it comprises a non-slip mesh layer and a loop layer arranged on the non-slip mesh layer, wherein the loop layer comprises a loop base layer formed by flat loops, and a plurality of vertical filaments and a plurality of arched loops erected on the loop base layer; both the vertical filaments and the arched loops are provided with particles, the non-slip mesh layer is of a porous structure, and the material for manufacturing the non-slip mesh layer comprises PVC and glass fibers;

the lower surface of the loop base layer is fixed on the non-slip mesh layer in an adhesive manner, upper ends of the vertical filaments form free ends above the non-slip mesh layer, and the height of the vertical filaments ranges from 8 to 16 mm; the height of the arched loops ranges from 6 to 12 mm;

the vertical filaments and the arched loops are made of cold-resistant material, and the cold-resistant material comprises a combination of polyvinyl chloride, toughened resin, plasticizer, cold-resistant plasticizer, stabilizer, lubricant, and calcium carbonate;

the particles are fixed on the vertical filaments and the arched loops in an adhesive manner, the material for manufacturing the particles comprises one or more of PVC resin powder, wood chips and fine sand, and the particle size of the particles ranges from 100 to 500 μm.

Further, the non-slip mesh layer is provided with square eyelets, the eyelets are arranged in an array, the side length of the eyelets ranges from 8 to 14 mm, and the edge width between adjacent eyelets ranges from 0.8 to 1.2 mm.

Further, the porous structure is arranged throughout on the non-slip mesh layer.

Further, the filament diameter of the vertical filaments ranges from 0.4 to 1 mm.

Further, the filament diameter of the arched loops ranges from 0.4 to 1 mm.

Further, the weight parts of the cold-resistant material are:

| | | |
|---|---|---|
| polyvinyl chloride | 5~100 | parts |
| toughened resin | 5~20 | parts |
| plasticizer | 50~80 | parts |
| cold-resistant plasticizer | 5~20 | parts |
| stabilizer | 3~6 | parts |
| lubricant | 0~1 | part |
| calcium carbonate | 30~50 | parts. |

Further, the vertical filaments are formed by cutting a part of the arched loops at the respective highest point thereof.

Further, the quantity ratio of the vertical filaments to the arched loops is less than or equal to 1:1.

Further, wherein the difference between the hardness value of the vertical filaments at 0° C. and the hardness value at 25° C. is no more than 4 HA; the difference between the hardness value of the arched loops at 0° C. and the hardness value at 25° C. is no more than 4 HA.

Further, the outer layers of the vertical filaments and of the arched loops are covered with a layer of adhesive layer, the particles comprise a plurality of particles with the same or different particle sizes, and the particles are fixed on the vertical filaments and the arched loops through the adhesive layer.

In yet another aspect, a manufacturing method for a non-slip cold-resistant loop mat is disclosed, comprising the following steps:
S11, molding a loop layer using a T-die, the loop layer comprises a plurality of arched loops;
S12, coating an adhesive layer on each of the arched loops of the loop layer, and performing a curing operation;
S13, fixing two ends of each arched loop on a non-slip mesh layer, and vertically arranging the arched loops on the non-slip mesh layer;
S14, cutting a part of the arched loops at respective highest point thereof to form independent vertical filaments;
S15, spraying particles onto the vertical filaments and the arched loops to make the particles adhere to the adhesive layer to obtain a semi-finished product;
S16, performing a plasticizing operation on the semi-finished product obtained in S15 to obtain a finished product.

In another aspect, a second manufacturing method for a non-slip cold-resistant loop mat is disclosed, comprising the following steps:
S21, molding a loop layer using a T-die, the loop layer comprises a loop base layer formed by flat loops and a plurality of arched loops erected on the loop base layer;
S22, coating an adhesive layer on the loop layer, and performing a curing operation, and performing a curing operation;
S23, fixing the lower surface of the loop base layer onto a non-slip mesh layer by an adhesive layer;
S24, cutting a part of the arched loops at respective highest point thereof to form independent vertical filaments;
S25, spraying particles onto the vertical filaments and the arched loops to make the particles adhere to the adhesive layer to obtain a semi-finished product;
S26, performing a plasticizing operation on the semi-finished product obtained in S25 to obtain a finished product.

The beneficial effects brought about by the technical solution provided by the present disclosure are as follows:
1) the coefficient of maximum static friction is controlled by the material, particle size, content, etc. of the particle layer, and the loop layer includes both the vertical filaments and the arched loops to increase the slip-resistance;
2) a frosted layer is formed on the surface of the loop mat by adjusting raw materials, formulas, and processes, which has a slip-resistant effect, and the materials of the frosted layer include PVC resin powder, wood chips, fly ash, sand and other materials that are not easy to plasticize;
3) the cold-resistant materials such as polyvinyl chloride, toughened resin, plasticizer, cold-resistant plasticizer, stabilizer, lubricant, and calcium carbonate are used to manufacture the loop layer, so that the overall hardness of the loop mat is less affected by temperature.

### BRIEF DESCRIPTION OF THE DRAWINGS

For more clearly explaining the technical solutions in the embodiments of the present disclosure, the accompanying drawings used to describe the embodiments are simply introduced in the following. Apparently, the below described drawings merely show a part of the embodiments of the present disclosure, and those skilled in the art can obtain other drawings according to the accompanying drawings without creative work.

FIG. 1 is a schematic structure diagram of a non-slip cold-resistant loop mat provided by an embodiment of the present disclosure;

FIG. 2 is a flow chart of a manufacturing method for a non-slip cold-resistant loop mat provided by an embodiment of the present disclosure;

FIG. 3 is a top view of a non-slip mesh layer provided by an embodiment of the present disclosure;

wherein, the reference signs: 1—non-slip mesh layer; 2—vertical filament; 3—arched loop; 4—particle.

### DETAILED DESCRIPTION OF EXEMPLARY EMBODIMENTS

In order to enable those skilled in the art to better understand the solutions of the present disclosure, the technical solutions in the embodiments of the present disclosure are explained clearly and completely below in conjunction with the accompanying drawings, and apparently, the described embodiments are merely a part of the embodiments of the present disclosure, not all the embodiments. Based on the embodiments of the present disclosure, all other embodiments obtained by one of ordinary skill in the art without creative work fall within the protective scope of the present disclosure.

It should be noted that terms “first”, “second” and the like in the description, the claims and the accompanying drawings of the present disclosure are used to distinguish similar objects, and do not have to be used to describe a specific order or sequence. It should be understood that the data so used can be interchanged under appropriate circumstances so that the embodiments of the present disclosure described herein can be implemented in an order other than those illustrated or described herein. In addition, the terms “comprise” and “have” in the description and claims of the present disclosure and any variations thereof are intended to cover non-exclusive inclusions, for example, processes, methods, devices, products, or equipment that include a series of steps or units are not necessarily limited to those clearly listed steps or units, but may include other steps or units not explicitly listed or inherent to these processes, methods, products or equipment.

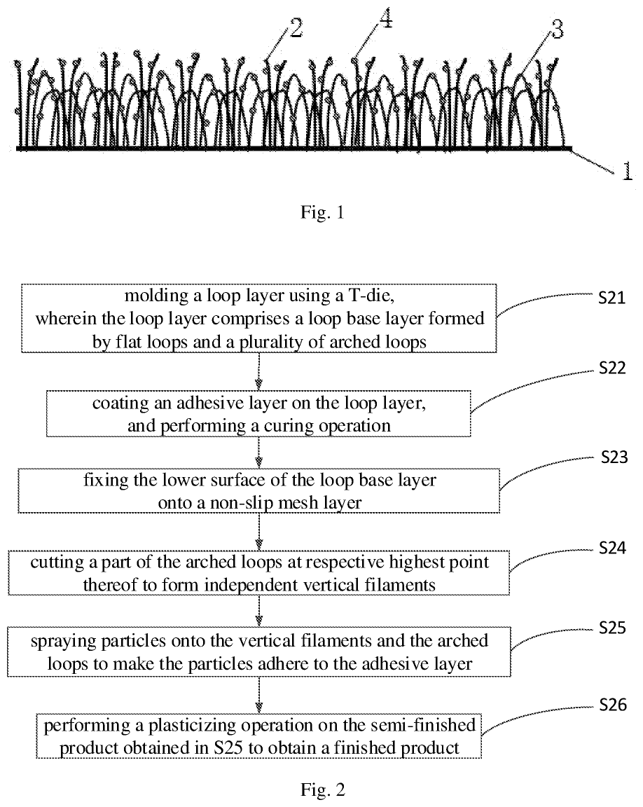

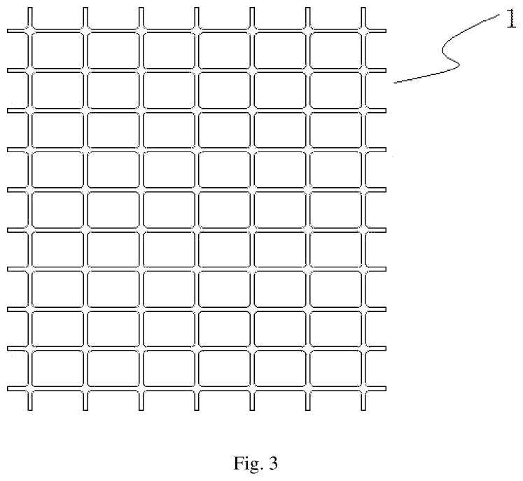

In severe cold weather, the pavement is easy to form an ice surface and becomes smooth, which is not conducive to the safe walking of pedestrians. In an embodiment of the present disclosure, a non-slip cold-resistant loop mat for laying on the ground is provided to increase the friction between pedestrians and the pavement; as shown in FIG. 1, the non-slip cold-resistant loop mat comprises a non-slip mesh layer 1 and a loop layer arranged on the non-slip mesh layer 1, wherein the loop layer comprises a loop base layer (not shown) formed by flat loops, and a plurality of vertical filaments 2 and a plurality of arched loops 3 erected on the loop base layer, both the vertical filaments 2 and the arched loops 3 are provided with particles 4, the non-slip mesh layer 1 is of a porous structure as shown in FIG. 3, and the non-slip mesh layer 1 is made of PVC and glass fibers, wherein the glass fibers could increase the overall dimensional stability of the product;

The lower surface of the loop base layer is fixed on the non-slip mesh layer 1 in an adhesive manner, lower ends of the vertical filaments 2 and two ends of the arched loops 3 are connected to the loop base layer through thermoplastic viscosity, upper ends of the vertical filaments 2 extend upward, the height of the vertical filaments 2 ranges from 8 to 16 mm, preferably 12 mm, and the filament diameter of the vertical filaments 2 ranges from 0.4 to 1 mm, preferably 0.5 mm; the height of the arched loops 3 ranges from 6 to 12 mm, preferably 10 mm, and the filament diameter of the arched loops 3 ranges from 0.4 to 1 mm, preferably 0.5 mm; the hardness of plastic usually increases with the decrease of temperature, the material of the vertical filaments 2 and the arched loops 3 in this embodiment is preferably the material of which the hardness does not increase much under low temperature condition compared with room temperature condition, for example, the hardness at 0° C. is about 4 HA higher than that at room temperature (such as 25° C.);

The vertical filaments 2 and two ends of the arched loops 3 are made of the cold-resistant material, the vertical filaments 2 can be absolutely vertical on the loop base layer, or the vertical filaments 2 are optionally obtained by cutting part of the arched loops 3 at the respective highest point thereof, therefore, as shown in FIG. 1, free ends of the vertical filaments 2 may not be absolutely vertical. The quantity ratio of the vertical filaments 2 to the arched loops 3 is less than or equal to 1:1, the cold-resistant materials comprise a combination of polyvinyl chloride, toughened resin, plasticizer, cold-resistant plasticizer, stabilizer, lubricant and calcium carbonate; the cold-resistant material of this embodiment is carried out the shock embrittlement temperature test of plastic, this test adopts the test standard of GB5470-85, this standard is suitable for measuring the embrittlement temperature of soft plastic, and the operation steps of the test are as follows:
1. Adding an appropriate amount of refrigerant and liquid heat transfer medium to the low temperature bath of the testing machine to make the bath temperature reach the range of +0.5 K of the required test temperature;
2. Making the cold-resistant material into sample filaments (such as the vertical filaments 2 and the arched loops 3), fixing the sample filaments on the fixture, and placing and fixing the fixture on the sample holder of the testing machine;
3. Immersing the sample holder in the liquid heat transfer medium controlled at the required test temperature, and keeping the temperature for 3 minutes;
4. Starting a shock hammer of the testing machine to shock the samples;
5. Taking out the samples from the low temperature bath, and recording the number of damaged samples, in which the samples shocked into two sections are recorded as damaged.

The test result is that there is no crack (or the failure rate of the samples is qualified) when the test temperature is −30° C. For the specific content of the test standard, refer to the document of the National Standard of the People's Republic of China GB5470-85, which will not be repeated here.

The particles 4 are fixed on the vertical filaments 2 and the arched loops 3 in an adhesive manner, the particles 4 are made of one or more of PVC resin powder, wood chips and fine sand, and the particle size of the particles 4 ranges from 100 to 500 μm. Specifically, the outer layers of the vertical filaments 2 and the arched loops 3 are both covered with a layer of adhesive layer, the thicknesses of the adhesive layer ranges from 10 to 50 μm, preferably 30 μm, the vertical filaments 2 and the arched loops 3 are fixed on the non-slip mesh layer 1 through the adhesive layer, the particles 4 comprise a plurality of particles with the same or different particle sizes, and the particles are fixed on the vertical filaments 2 and the arched loops 3 through the adhesive layer. The particle size of the particles 4 is diversified, and they are adhered to the adhesive layer by the characteristic that the particles are difficult to plasticize or not plasticize at 160° C.; after molding, the surface has obvious sand-granular to achieve the slip-resistant effect, wherein the particles may be selected from PVC resin powder or wood chips or fine sand, etc., with different particle sizes and different slip-resistant properties. The coefficient of maximum static friction of the non-slip cold-resistant loop mat of the present disclosure ranges from 0.6 to 0.95, and is controlled by the material, particle size, content, etc. of the particle layer; in this embodiment, the loop layer comprises both the vertical filaments 2 and the arched loops 3 to increase the slip-resistance. For example:

Evenly spray 100 g of wood chips per square meter, the wood chips are 50 mesh, and after plasticization, the coefficient of maximum static friction is 0.62.

As shown in FIG. 3, eyelets on the non-slip mesh layer 1 are square, and the porous structure is arranged through the non-slip mesh layer 1. The eyelets are arranged in an array, the side length of the eyelets ranges from 8 to 14 mm, such as 12 mm of length and 10 mm of width, and the edge width between adjacent eyelets ranges from 0.8 to 1.2 mm, such as 1 mm.

In a preferred embodiment of the present disclosure, the cold-resistant materials comprise a combination of polyvinyl chloride, toughened resin, plasticizer, cold-resistant plasticizer, stabilizer, lubricant, and calcium carbonate, preferably, the weight parts of the cold-resistant materials are:

| | | |
|---|---|---|
| polyvinyl chloride | 75 | parts |
| toughened resin | 12 | parts |
| plasticizer | 75 | parts |
| cold-resistant plasticizer | 12 | parts |
| stabilizer | 5 | parts |
| lubricant | 1 | part |
| calcium carbonate | 40 | parts. |

After many tests, the present disclosure obtains that the above formula is an optimal one for making the cold-resistant non-slip loop mat, which can realize the minimum hardness change of the loop mat under two conditions of room temperature and 0° C., which is less than 3 HA. Similarly, the shock embrittlement temperature test of plastic is carried out on the cold-resistant material of the embodiment of the present disclosure, this test adopts the test standard of GB5470-85, and the test result is that there is no crack (or the failure rate is qualified) when the testing temperature is −30° C.

In other optional embodiment, the weight parts of the cold-resistant materials are:

| | | |
|---|---|---|
| polyvinyl chloride | 50 | parts |
| toughened resin | 5 | parts |
| plasticizer | 50 | parts |
| cold-resistant plasticizer | 5 | parts |
| stabilizer | 3 | parts |
| calcium carbonate | 50 | parts; |

At this moment, the hardness change of the loop mat under two conditions of room temperature and 0° C. is 3.6 HA. Similarly, the shock embrittlement temperature test of plastic is carried out on the cold-resistant material of the embodiment of the present disclosure, this test adopts the test standard of GB5470-85, and the test result is that there is no crack (or the failure rate is qualified) when the testing temperature is −30° C.

In this embodiment, the T-die is used to mold the loop layer, the height of a single layer of vertical filaments is 8 mm and the filament diameter is 0.6 mm, the thickness of the adhesive layer is 30 μm, and after sintering, 70 g of PVC resin powder is sprayed evenly per square meter, the particle size of the PVC resin powder is about 250 μm, and they are plasticized together with the non-slip mesh layer, the specific gravity of the non-slip mesh layer is 0.6 g/m³, the overall grounding performance thereof is good, the coefficient of maximum static friction is 0.9, and due to the porous structure, the slip resistance and hydrophobicity are further enhanced.

The weight parts of the cold-resistant materials are:

| | | |
|---|---|---|
| polyvinyl chloride | 100 | parts |
| toughened resin | 20 | parts |
| plasticizer | 80 | parts |
| cold-resistant plasticizer | 20 | parts |
| stabilizer | 6 | parts |
| lubricant | 1 | part |
| calcium carbonate | 30 | parts. |

At this moment, the hardness change of the loop mat under two conditions of room temperature and 0° C. is 3.8 HA. Similarly, the shock embrittlement temperature test of plastic is carried out on the cold-resistant material of the embodiment of the present disclosure, this test adopts the test standard of GB5470-85, and the test result is that there is no crack (or the failure rate is qualified) when the testing temperature is −30° C.

In this embodiment, the T-die is used to mold the loop layer, the height of a single layer of vertical filaments is about 9 mm and the filament diameter is 0.4 mm, the thickness of the adhesive layer is 25 μm, and after sintering, 120 g of fly ash is sprayed evenly per square meter, the particle size of the fly ash is about 100 mesh, and they are plasticized together with the non-slip mesh layer, the specific gravity of the non-slip mesh layer is 0.6 g/m³, the overall grounding performance is good, the coefficient of maximum static friction is 0.8, and due to the porous structure, the slip resistance and hydrophobicity are further enhanced.

In an embodiment of the present disclosure, a manufacturing method for a non-slip cold-resistant loop mat is disclosed, as shown in FIG. 2, the manufacturing method comprises the following steps:
S21, molding a loop layer using a T-die, the loop layer comprises a loop base layer formed by flat loops and a plurality of arched loops erected on the loop base layer;
S22, coating an adhesive layer on the loop layer, and performing a curing operation;
S23, fixing the lower surface of the loop base layer onto a non-slip mesh layer;
S24, cutting a part of the arched loops at respective highest point thereof to form independent vertical filaments;
S25, spraying particles onto the vertical filaments and the arched loops to make the particles adhere to the adhesive layer to obtain a semi-finished product;
S26, performing a plasticizing operation on the semi-finished product obtained in S25 to obtain a finished product.

The manufacturing method provided by the embodiment of the present disclosure may be used to make the non-slip cold-resistant loop mat provided by the above embodiment. Specifically, the filament diameter of the vertical filaments 2 of the manufactured non-slip cold-resistant loop mat ranges from 0.4 to 1 mm, the filament diameter of the arched loops 3 ranges from 0.4 to 1 mm, the difference between the hardness value of the vertical filaments 2 at 0° C. and hardness value at 25° C. is no more than 4 HA, the difference between the hardness value of the arched loops 3 at 0° C. and hardness value at 25° C. is no more than 4 HA, and the quantity ratio of the vertical filaments 2 formed by cutting part of the arched loops to the arched loops 3 is less than or equal to 1:1.

The cold-resistant material is used to manufacture the loops of the non-slip cold-resistant loop mat of the present disclosure, such that the influence of the temperature on the hardness of the overall loop mat is small, the non-slip cold-resistant loop mat is suitable for outdoor pavements in severely cold weather, and the anti-slip performance of the loop mat is improved, thereby improving the safety of a user for use.

Further, the above are only preferred embodiments of the present disclosure, and are not intended to limit the present disclosure. Any modifications, equivalent substitutions, improvements, etc. made within the spirit and principle of the present disclosure shall be included in the protective scope of the present disclosure.

1. A non-slip cold-resistant loop mat, comprising a non-slip mesh layer, a plurality of vertical filaments and a plurality of arched loops arranged on the non-slip mesh layer, and particles arranged on the vertical filaments and the arched loops, wherein the non-slip mesh layer is of a porous structure, and the material for manufacturing the non-slip mesh layer comprises PVC and glass fibers;
lower ends of the vertical filaments are fixed on the non-slip mesh layer in an adhesive manner, upper ends of the vertical filaments extend upwards, and the height of the vertical filaments ranges from 8 to 16 mm;
two ends of the arched loops are respectively fixed on the non-slip mesh layer in an adhesive manner, the arched loops are erectly arranged, and the height of the arched loops ranges from 6 to 12 mm;
the vertical filaments and the arched loops are made of cold-resistant material, and the cold-resistant material comprises polyvinyl chloride, toughened resin, plasticizer, cold-resistant plasticizer, stabilizer, lubricant, and calcium carbonate;
the particles are fixed on the vertical filaments and the arched loops in an adhesive manner, the material for manufacturing the particles comprises PVC resin powder, wood chips and fine sand, and the particle size of the particles ranges from 100 to 500 μm.

2. The non-slip cold-resistant loop mat according to claim 1, wherein the non-slip mesh layer is provided with square eyelets, the eyelets are arranged in an array, the side length of the eyelets ranges from 4 to 10 mm, the distance between adjacent eyelets in the same row ranges from 9 to 21 mm, and the distance between adjacent eyelets in the same column ranges from 9 to 21 mm.

3. The non-slip cold-resistant loop mat according to claim 1, wherein the filament diameter of the vertical filaments ranges from 0.4 to 1 mm.

4. The non-slip cold-resistant loop mat according to claim 1, wherein the filament diameter of the arched loops ranges from 0.4 to 1 mm.

5. The non-slip cold-resistant loop mat according to claim 1, wherein the weight parts of the cold-resistant material are:

| | | |
|---|---|---|
| polyvinyl chloride | 5~100 | parts |
| toughened resin | 5~20 | parts |
| plasticizer | 50~80 | parts |
| cold-resistant plasticizer | 5~20 | parts |
| stabilizer | 3~6 | parts |
| lubricant | 0~1 | part |
| calcium carbonate | 30~50 | parts. |

6. The non-slip cold-resistant loop mat according to claim 1, wherein the vertical filaments are formed by cutting a part of the arched loops at respective highest point thereof.

7. The non-slip cold-resistant loop mat according to claim 6, wherein the quantity ratio of the vertical filaments to the arched loops is less than or equal to 1:1.

8. The non-slip cold-resistant loop mat according to claim 1, wherein the difference between the hardness value of the vertical filaments at 0° C. and the hardness value at 25° C. is no more than 4 HA; the difference between the hardness value of the arched loops at 0° C. and the hardness value at 25° C. is no more than 4 HA.

9. The non-slip cold-resistant loop mat according to claim 1, wherein outer layers of the vertical filaments and of the arched loops are covered with a layer of adhesive layer, the vertical filaments and the arched loops are fixed on the non-slip mesh layer through an adhesive layer, the particles comprise a plurality of particles with the same or different particle sizes, and the particles are fixed on the vertical filaments and the arched loops through the adhesive layer.

10. A non-slip cold-resistant loop mat, comprising a non-slip mesh layer and a loop layer arranged on the non-slip mesh layer, wherein the loop layer comprises a loop base layer formed by flat loops, and a plurality of vertical filaments and a plurality of arched loops erected on the loop base layer; both the vertical filaments and the arched loops are provided with particles, the non-slip mesh layer is of a porous structure, and the material for manufacturing the non-slip mesh layer comprises PVC and glass fibers;
the lower surface of the loop base layer is fixed on the non-slip mesh layer in an adhesive manner, upper ends of the vertical filaments form free ends above the non-slip mesh layer, and the height of the vertical filaments ranges from 8 to 16 mm; the height of the arched loops ranges from 6 to 12 mm;
the vertical filaments and the arched loops are made of cold-resistant material, and the cold-resistant material comprises a combination of polyvinyl chloride, toughened resin, plasticizer, cold-resistant plasticizer, stabilizer, lubricant and calcium carbonate;
the particles are fixed on the vertical filaments and the arched loops in an adhesive manner, the material for manufacturing the particles comprises one or more of PVC resin powder, wood chips and fine sand, and the particle size of the particles ranges from 100 to 500 μm.

11. The non-slip cold-resistant loop mat according to claim 10,
wherein the non-slip mesh layer is provided with square eyelets, the eyelets are arranged in an array, the side length of the eyelets ranges from 8 to 14 mm, and the edge width between adjacent eyelets ranges from 0.8 to 1.2 mm.

12. The non-slip cold-resistant loop mat according to claim 10,
wherein the porous structure is arranged throughout on the non-slip mesh layer.

13. The non-slip cold-resistant loop mat according to claim 10,
wherein the filament diameter of the vertical filaments ranges from 0.4 to 1 mm, and the filament diameter of the arched loops ranges from 0.4 to 1 mm.

14. The non-slip cold-resistant loop mat according to claim 10, wherein the weight parts of the cold-resistant material are:

| | | |
|---|---|---|
| polyvinyl chloride | 5~100 | parts |
| toughened resin | 5~20 | parts |
| plasticizer | 50~80 | parts |
| cold-resistant plasticizer | 5~20 | parts |
| stabilizer | 3~6 | parts |
| lubricant | 0~1 | part |
| calcium carbonate | 30~50 | parts. |

15. The non-slip cold-resistant loop mat according to claim 10, wherein the vertical filaments are formed by cutting a part of the arched loops at respective highest point thereof.

16. The non-slip cold-resistant loop mat according to claim 15, wherein the quantity ratio of the vertical filaments to the arched loops is less than or equal to 1:1.

17. The non-slip cold-resistant loop mat according to claim 10, wherein the difference between the hardness value of the vertical filaments at 0° C. and the hardness value at 25° C. is no more than 4 HA; the difference between the hardness value of the arched loops at 0° C. and the hardness value at 25° C. is no more than 4 HA.

18. The non-slip cold-resistant loop mat according to claim 10, wherein the outer layers of the vertical filaments and of the arched loops are covered with a layer of adhesive layer, the particles comprise a plurality of particles with the same or different particle sizes, and the particles are fixed on the vertical filaments and the arched loops through the adhesive layer.

19. A manufacturing method for a non-slip cold-resistant loop mat, comprising following steps:
molding a loop layer using a T-die, the loop layer comprises a plurality of arched loops;
coating an adhesive layer on each of the arched loops of the loop layer, and performing a curing operation;
fixing two ends of each arched loop on a non-slip mesh layer, and vertically arranging the arched loops on the non-slip mesh layer;
cutting a part of the arched loops at respective highest point thereof to form independent vertical filaments;
spraying particles onto the vertical filaments and the arched loops to make the particles adhere to the adhesive layer to obtain a semi-finished product;
performing a plasticizing operation on the semi-finished product obtained in previous step to obtain a finished product.

20. A manufacturing method for a non-slip cold-resistant loop mat,
comprising following steps:
molding a loop layer using a T-die, the loop layer comprises a loop base layer formed by flat loops and a plurality of arched loops erected on the loop base layer;
coating an adhesive layer on the loop layer, and performing a curing operation, and performing a curing operation;
fixing the lower surface of the loop base layer onto a non-slip mesh layer by an adhesive layer;
cutting a part of the arched loops at respective highest point thereof to form independent vertical filaments;
spraying particles onto the vertical filaments and the arched loops to make the particles adhere to the adhesive layer to obtain a semi-finished product;
performing a plasticizing operation on the semi-finished product obtained in previous step to obtain a finished product.
